(19) United States
(12) Patent Application Publication
(10) Pub. No.: US 2005/0148254 A1
(43) Pub. Date: Jul. 7, 2005

(54) Light-activated biocidal polyelectrolytes

(76) Inventors: Liangde Lu, Albuquerque, NM (US); Frauke Rininsland, Santa Fe, NM (US); Shannon Wittenburg, Santa Fe, NM (US); Komandoor Achyuthan, Santa Fe, NM (US); Duncan McBranch, Santa Fe, NM (US); David Whitten, Albuquerque, NM (US)

Correspondence Address: Supervisor, Patent Prosecution Services;PIPER RUDNICK LLP, 1200 Nineteenth Street, N.W., Washington, DC, 20036-2412, US

(21) Appl. No.: 11/012,187

(22) Filed: Dec. 16, 2004

Related U.S. Application Data
(60) Provisional application No. 60/532,893, filed on Dec. 30, 2003.

(51) Int. Cl. B32B 5/02

(52) U.S. Cl. 442/123

(57) ABSTRACT

Compositions including biocidal reagents and articles treated or coated therewith are described. The compositions can be used to make passive biocidal surfaces. Exemplary biocidal reagents include visible light-absorbing polyelectrolytes which act as passive biocides upon exposure to radiation, including relatively weak “background” radiation such as natural light sources (e.g., indirect sunlight) and artificial light sources. Methods of treating or coating surfaces with the compositions are also described.

This application claims the benefit of U.S. Provisional Patent Application Ser. No. 60/532,893, filed Dec. 30, 2003. The entirety of that provisional application is incorporated herein by reference.

### BACKGROUND

1. Technical Field

The present application relates generally to biocidal reagents that can be used to make passive biocidal surfaces. In particular, the present application relates to visible light-absorbing polyelectrolytes that can be used as passive biocides upon exposure to radiation, including relatively weak “background” radiation from natural light sources (e.g., indirect sunlight) and artificial light sources.

2. Background of the Technology

Recently, there has been much interest from several different sectors in interfacial coatings (e.g., solid-liquid and solid-vapor) that exhibit efficient biocidal activity against bacteria, bacterial spores and other agents. Among the systems that have been proposed and/or developed are metal ion containing formulations [1-6], coated and uncoated semiconductor particles [3, 7] and polymer blends or surfactants containing pendant reactive organic functionalities (i.e., quaternary ammonium groups, hydantoins, tetramisole derivatives or alkyl pyridinium structures) that may or may not require additional reagents for activation of biocidal function [8-19].

There still exists a need for improved biocidal agents and compositions which exhibit biocidal activity. In particular, there exists a need for biocidal agents which exhibit biocidal activity for gram-negative bacteria (e.g., Escherichia coli) as well as gram-positive bacterial spores (e.g., Bacillus anthracis).

### SUMMARY

According to a first embodiment, method of inhibiting the growth of a bacterium is provided which comprises:
associating a composition comprising a polymer with the surface of the bacterium; and
subsequently exposing the bacterium to light;
wherein the polymer is selected from the group consisting of a conjugated cationic polyelectrolyte, a neutral conjugated polymer, a dye pendant polymer and copolymers thereof. According to one embodiment, the polymer can be a conjugated cationic polyelectrolyte such as poly(phenylene ethynylene). For example, the polymer can include a repeating unit having a structure represented by the following formula: 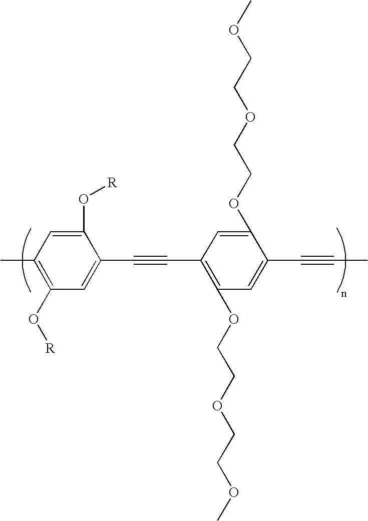
   wherein each R independently represents an alkyl quaternary ammonium group or an alkyl pyridinium group. Exemplary polymers include those having a repeating unit represented by the formula: 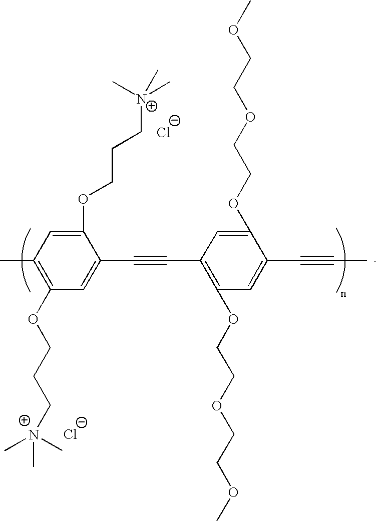
   In the above described method, exposing can include exposing the bacterium to fluorescent light.

According to a second embodiment, an article of manufacture is provided which comprises:
a textile; and
a polymer associated with the textile;
wherein the polymer is selected from the group consisting of a conjugated cationic polyelectrolyte, a neutral conjugated polymer, a dye pendant polymer and copolymers thereof. The article can be a jacket or a sock. The textile can comprise cotton or flax fibers. The textile can also be a rope or a cord.

According to a third embodiment, a foam composition is provided which comprises a polymer selected from the group consisting of a conjugated cationic polyelectrolyte, a neutral conjugated polymer, a dye pendant polymer and copolymers thereof. The polymer can be a conjugated cationic polyelectrolyte. For example, the polymer can include a poly(phenylene ethynylene) backbone.

According to a fourth embodiment, a fuel composition is provided which comprises a polymer selected from the group consisting of a conjugated cationic polyelectrolyte, a neutral conjugated polymer, a dye pendant polymer and copolymers thereof. The polymer can be a conjugated cationic polyelectrolyte. For example, the polymer can include a poly(phenylene ethynylene) backbone. The fuel composition can be a jet fuel.

According to a fifth embodiment, a paint composition is provided which comprises a polymer selected from the group consisting of a conjugated cationic polyelectrolyte, a neutral conjugated polymer, a dye pendant polymer and copolymers thereof. The polymer can be a conjugated cationic polyelectrolyte. For example, the polymer can include a poly(phenylene ethynylene) backbone.

According to a sixth embodiment, a method of disinfecting a surface is provided which comprises:
contacting the surface with a composition comprising a polymer selected from the group consisting of a conjugated cationic polyelectrolyte, a neutral conjugated polymer, a dye pendant polymer and copolymers thereof; and
subsequently exposing the surface to light.

According to a seventh embodiment, a method of providing an article with a passive biocidal surface is provided which comprises:
coating a surface of the article with a composition comprising a polymer selected from the group consisting of a conjugated cationic polyelectrolyte, a neutral conjugated polymer, a dye pendant polymer and copolymers thereof;
wherein the coating forms a passive biocidal surface on the article.

### BRIEF DESCRIPTION OF THE DRAWINGS

FIGS. 1A-1E show chemical structures of biocidal agents according to various embodiments of the invention.

FIGS. 2A-2D are phase contrast (FIGS. 2A and 2C) and fluorescence (FIGS. 2B and 2D) microscope images of E. coli (FIGS. 2A and 2B) and B. anthracis (FIGS. 2C and 2D) spores treated with a polymeric biocidal agent (PPE).

FIGS. 3A and 3B are schematic representations showing the “inner filter effect” of PPE coated bacterial spores.

FIG. 4 is a graph showing absorbance at 560 nm versus the growth period (hours) of a sample comprising E. coli treated with PPE compared to a control containing untreated E. coli.

FIG. 5 is a graph showing absorbance at 560 nm versus the growth period (hours) of samples containing E. coli treated with cetylpyridinium chloride (CPC) compared to a control containing untreated E. coli.

### DETAILED DESCRIPTION

Conjugated polyelectrolytes (CPs) have been shown in a number of investigations to exhibit limited water solubility and to spontaneously coat close to monolayer coverage when exposed to solid surfaces having surface charge opposite to the conjugated polyelectrolyte [20-23]. Further, the properties of specific conjugated polyelectrolytes may be tuned so that the coating process is irreversible, rendering the coatings robust and stable in the presence and absence of interfacial water [23]. In particular, assemblies containing conjugated polyelectrolytes have been shown to be the basis of practical biosensors since the anchored conjugated polyelectrolytes may exhibit the important combination of properties of efficient light harvesting, excitonic delocalization and excited state superquenching that can be coupled with biodetection by the use of synthetic quencher conjugates [20, 22-26].

The ability to readily synthesize conjugated polyelectrolytes in a range of molecular weights and structures incorporating both the conjugated polyelectrolyte chromophore backbone and additional functionality (e.g., quaternary ammonium groups) suggests that they should provide an attractive platform for a passive biocide either in the dark or under relatively weak illumination affording excitation of the conjugated polyelectrolyte chromophore. Additionally, the use of conjugated polyelectrolytes in specific bioagent detection assays where the conjugated polyelectrolyte and a specific receptor for the bioagent are co-located on the surface of a planar solid support or a nanoparticle suggests the possibility that systems may be constructed where detection and destruction may be interconnected and where the biocidal action of a conjugated polyelectrolyte may be rendered specific and highly effective to a given agent. By extension, co-locating different receptors to various bioagents and toxins with conjugated polyelectrolytes will permit multiplexed detection and destruction of several different targets.

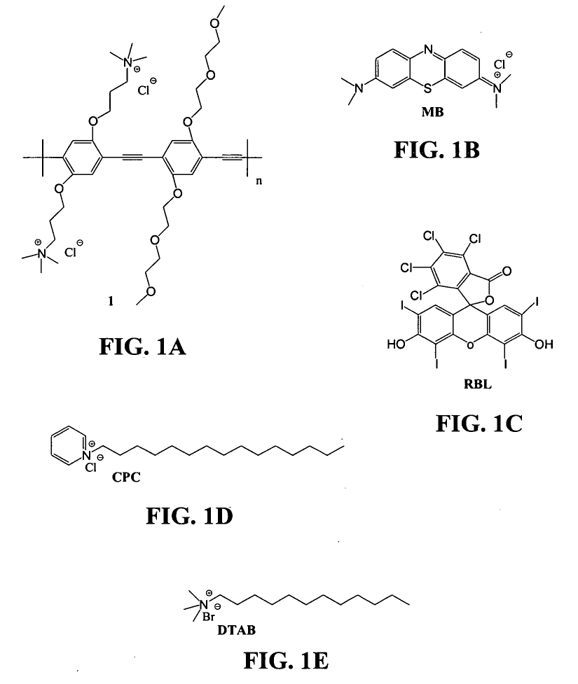

According to a first embodiment, a cationic conjugated polyelectrolyte having a structure as shown in FIG. 1A (hereinafter referred to as “polymer 1”) is provided which shows biocidal activity against (gram-negative) bacteria (E. coli, BL21, with plasmids for Azurin and ampicillin resistance) and bacterial (gram-positive) spores (B. anthracis, Sterne). Polymer 1 is active as a biocide both in aqueous solution as well as in supported formats. The present inventors have also discovered that polymer 1 is active as a biocide for samples in which the cationic conjugated polyelectrolyte was directly coated onto the bacteria. Further, the biocidal activity of polymer 1 is light-induced (i.e., little or no biocidal activity was observed under yellow light treatment of the cationic conjugated polyelectrolyte) and is shown to be effective due to the ability of the cationic conjugated polyelectrolyte to form a surface coating on both types of bacteria.

As can be seen from FIG. 1A, polymer 1 consists of a poly(phenylene ethynylene) (PPE) conjugated backbone which provides a light-harvesting visible light absorbing polychromophore and functionalization on each polymer repeat unit (PRU) of the polymer. In the case of polymer 1, the pendant quaternary ammonium groups may contribute to the biocidal properties since quaternary ammonium surfactants by themselves exhibit biocidal activity.

According to a further embodiment, modification of the pendant groups on a biocidal polymer (e.g., polymer 1) provides an opportunity for tuning the biocidal properties of the polymer. For example, depending on the length of the chain and the substituent, the biocidal properties may be enhanced or attenuated. As an example, replacement of a quaternary ammonium group on a polymer comprising such groups with an alkyl pyridinium substituent may provide a more active biocidal polymer.

Polymers having similar light-absorbing properties to polymer 1 and a suitable charge distribution to allow near-monolayer coverage of a support (e.g., beads, planar solid or corrugated solid surfaces) are provided. Exemplary polymers include, but are not limited to, conjugated polyelectrolytes, neutral conjugated polymers, dye-pendant polymers, polymer blends and co-polymers. As discussed in detail below, the polymers may be used in solution, in gels, or affixed to a support. The polymers may be affixed to the support by, for example, simple adsorption, by biotin-biotin binding protein interactions, by combination with other polymers as blends or copolymers which promote interfacial activity, or by covalent linkage. The biocidal polymers may be applied as a paint, spray or dip coating to a surface. These polymers are passive biocidal agents that can be used in conjunction with other polymers. Further, other functionalities can be added to the polymer backbone. In addition, these polymers can also be used in conjunction with specific biological ligands which may be used to impart bioagent specificity in dark and light-induced biocidal activity.

According to one embodiment a cationic polyelectrolyte such as polymer 1 is anchored to a surface by exposure from an aqueous solution. Polymer 1 is water soluble. However, upon exposure to the surface of a solid support (e.g., a bead, a planar or corrugated support, or bacteria) it adsorbs irreversibly to the surface. If the surface-support bears only a slight net anionic charge, the coated surface will bear a net positive charge and still be able to associate with agents such as bacteria or spores that bear a negative surface charge. This allows the surface-bound polymer to capture bacteria, spores or other agents that reach the coated surface (e.g., via air or aerosols). The polymer can partially coat the surface of the cell and, upon irradiation, deactivate or kill the agent.

According to a further embodiment, specificity and capture efficiency may be improved by co-locating a polymer and a specific capture ligand for the target bioagent. Exemplary ligands include, but are not limited to, a capture peptide, an aptamer, or an antibody. The polymer and ligand may be co-located on the surface by simultaneous or consecutive adsorption or via a covalent linkage. Techniques for applying polymer and ligand to solid support surfaces are disclosed in U.S. patent application Ser. No. 10/098,387, filed Mar. 18, 2002, which application is incorporated herein by reference in its entirety. This application also discloses fluorescent polymer compositions, including compositions comprising microspheres. Any of these compositions may also be used as surface coatings for biocidal applications.

### EXAMPLE

The polymer used in the investigations described below is polymer 1 having a structure as shown in FIG. 1A. This polymer has been used in biosensing experiments [25, 26]. The polymer is water soluble yet forms a coating on oppositely charged particles such as carboxyl functionalized polystyrene microspheres. MALDI-TOF investigations indicate that the polymer may have approximately 144 polymer repeat units (PRU).

Initial experiments involved incubating B. anthracis spores and E. coli bacteria with the polymer and comparing the survival rate of the coated bacteria with bacteria not exposed to polymer 1. Bacillus anthracis was grown on 5% sheep blood agar (SBA) plates (BD Biosciences, Cockeysville, Md.). Escherichia coli was grown in Luria-Bertani (LB) medium in the presence of 50 mg/mL ampicillin. Escherichia coli cells were grown at either 37° C. or 25° C. according to the conditions described previously [27]. Bacillus anthracis spores were germinated at 37° C. on sheep-blood-agar (SBA) plates as described previously [28]. Both types of bacterial cells could be stained using methylene blue (vide infra) [29, 30].

Results of the initial experiments are summarized in Table 1 which shows the biocidal activity of various formulations toward Bacillus anthracis spore growth.

TABLE 1
Biocidal Activity of Various Formulations Toward Bacillus anthracis
Spore Growth

| Treatment | Spore colonies | % killing |
|---|---|---|
| Control | 130 ± 10 | 0 |
| PPE-NR₃⁺(1) | 93 ± 4 | 30 |
| Control Bead 1266 | 122 ± 11 | 0 |
| Bead 1268 | 71 ± 3 | 42 |
| Bead 1255 | 73 ± 9 | 40 |
| Bead-NR₃⁺ | 70 ± 3 | 43 |
| Bead-CO₂ | 122 ± 8 | 0 |
| DTAB | 84 ± 4 | 40 |

For the data shown in Table 1, the Polymer 1 concentration was 10⁻⁵ M, the control was spores alone in deionized water. In addition, each sample contained approximately 130 spores. The concentration of DTAB is 2×10⁻⁵ M, “1266” is a “control” polystyrene-Neutravidin microsphere (0.6 μm), “1268” is a polystyrene-Neutravidin microsphere (0.6 μm) comprising polymer 1 at a level of 1.1×10⁶ PRU/microsphere, “1255” is a polystyrene-Neutravidin microsphere (0.6 μm) with polymer 1 at a level of 7.8×10⁶ PRU/microsphere, “Bead-NR₃⁺” is a 0.2 μm bead with quaternary ammonium groups and “Bead-CO₂⁻” is a carboxylate functionalized microsphere. The bead concentration in each case is approximately 500 microspheres per spore.

These experiments were carried out with initial polymer concentrations of 1×10⁻⁵ M to 2×10⁻⁶ M. For both bacteria it was found that incubation with the polymer resulted in an approximately 40% reduction of bacterial survival. Both bacteria were treated with microsphere-supported suspensions of polymer 1. In these cases, there was also a modest (i.e., ˜40%) reduction of bacterial survival following incubation over 1.5 hours. In contrast, anionic (carboxyl functionalized) microspheres by themselves had no effect on B. anthracis (Sterne) spores survival. Similar experiments with ammonium derivatized microspheres resulted in a reduction of survival corresponding to that of the microsphere-supported polymer 1. Experiments with the quaternary ammonium surfactant dodecyltrimethylammonium bromide (DTAB) at a concentration of 2×10⁻⁵ M showed an approximately 40% reduction in bacterial survival following 1.5 hours incubation under fluorescent laboratory lighting conditions. For the surfactant, it was found that reduction of bacterial survival increased with a decrease in DTAB concentration over the range of 1×10⁻³ to 3×10⁻⁵ M.

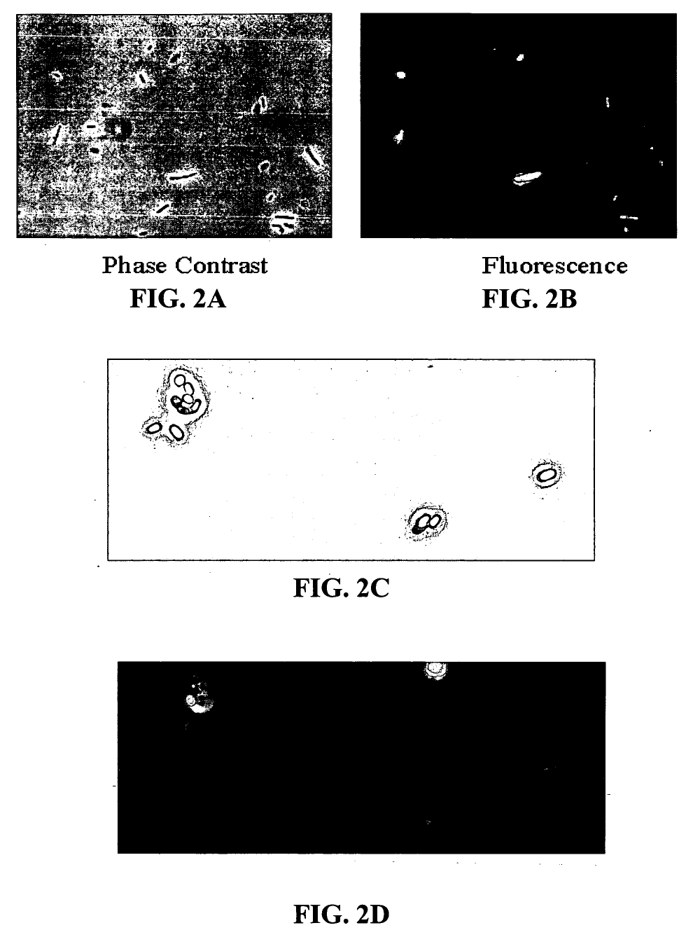

Studies by fluorescence and phase contrast microscopy indicated that polymer 1 is taken up by both bacteria and that the polymer coated on either the spores or bacteria is strongly fluorescent. This is shown in FIGS. 2A-2D which are phase contrast (FIGS. 2A and 2C) and fluorescence (FIGS. 2B and 2D) microscope images of PPE-treated E. coli (FIGS. 2A and 2B) and B. anthracis (FIGS. 2C and 2D) spores. Since polymer 1 absorbs broadly through the visible region, it is possible that samples of bacteria incubated in room light could be undergoing both dark and photoinitiated interactions with the polymer. Preliminary attempts to separate the two effects indicated that there was a somewhat lower reduction of B. anthracis survival when bacterial spores and polymer 1 were incubated under yellow light which is not absorbed to an appreciable extent by polymer 1. For example, it was found (See Table 2, below) that incubation of B. anthracis spores with polymer 1 at concentrations in the range of 1×10⁻⁴ M to 1×10⁻⁵ M under fluorescent lighting for two (2) hours showed an inverse dependence of reduction of bacterial survival with polymer concentration. Thus at moderate to high polymer concentrations, there is almost no observed reduction of bacterial survival.

TABLE 2
Concentration Effects on the Biocidal Activity of PPE Toward Bacillus
anthracis Spore Growth

| Concentrations of PPE- | | |
|---|---|---|
| NR₃⁺ | Spore colonies | % killing |
| 0 (control) | 72 ± 8 | 0 |
| 1.1 × 10⁻³ M | 75 ± 3 | 0 |
| 2.8 × 10⁻⁴ M | 55 ± 2 | 23 |
| 1.1 × 10⁻⁴ M | 59 ± 3 | 18 |
| 2.8 × 10⁻⁵ M | 64 ± 4 | 11 |
| 1.1 × 10⁻⁵ M | 48 ± 3 | 33 |
| 2.8 × 10⁻⁶ M | 52 ± 2 | 28 |
| 1.1 × 10⁻⁶ M | 45 ± 1 | 38 |
| 2.8 × 10⁻⁷ M | 46 ± 4 | 37 |

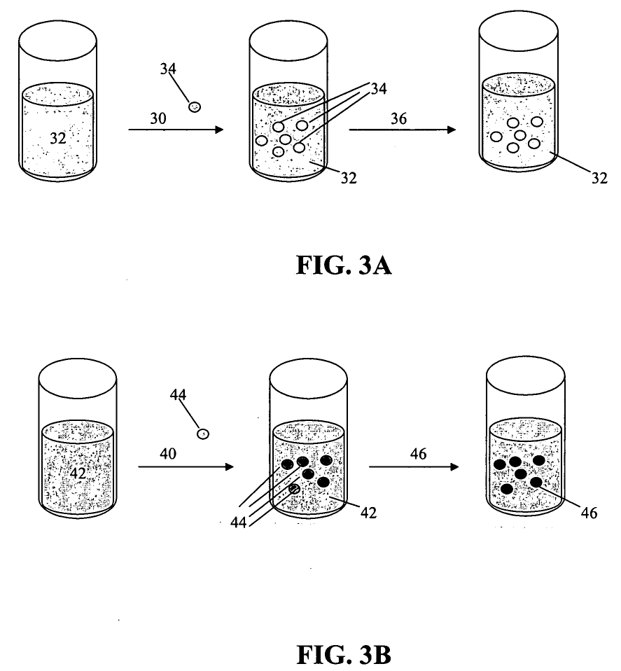

While not wishing to be bound by theory, the near complete “protection” of the spores afforded by high polymer concentrations suggested that the reduction of bacterial survival was due to a photoinitiated process and that large excesses of polymer in solution beyond that taken up by the bacteria might be affording protection of the polymer-coated bacteria by an “inner filter effect”. This effect is illustrated in FIGS. 3A and 3B.

As shown in FIG. 3A, when spores 34 are added 30 to a solution of biocidal polymer (e.g., PPE) containing excess polymer 32, irradiation of the solution (e.g., with room light) 36 results in a diminished killing of the spores. As set forth above, this phenomenon is referred to as the “inner filter effect”.

In contrast, when lower concentrations of biocidal polymer are used, this effect does not occur. For example, as shown in FIG. 3B, when spores 44 are added 40 to a solution containing lower concentrations of biocidal polymer 42, irradiation of the solution (e.g., with room light) 46 results in effective killing of the spores.

To test this a series of experiments were carried out to determine the level of adsorptive coating of polymer 1 on B. anthracis spores and to isolate the behavior of the polymer 1 coated spores. Using different concentrations of polymer 1, a “subtractive” assay of polymer uptake by spores was obtained by measuring the optical density both before and after addition of the spores followed by removal of the spores by centrifugation. The average uptake of PRU/spore was found to be 2×10⁷ to 3×10⁷. It is reported that the dimensions (i.e., the length and width of the spore assuming a cylindrical shape) of a single Bacillus anthracis spore are approximately 0.95 and 3.5 μm, respectively. [31, 32] It is also known that the Escherichia coli bacterium dimensions (i.e., the length and width assuming a cylindrical shape) are nominally 2 μm and 0.5 μm, respectively [33, 34]. The area of a Bacillus anthracis spore and of a Escherichia coli were calculated by the following equation:
area=2πr²+2πrh
wherein: π=nominally, 22/7; r=radius; and h=height or length. The surface area of the Bacillus anthracis spore was calculated to be 11.9 μm² and the surface area of Escherichia coli was computed to be 3.5 μm². These dimensions then equal to 11.9×10⁸ Å² and 3.5×10⁸ Å², respectively. The surface area occupied by polymer 1 is estimated to be approximately 120 Å² per polymer repeat unit (PRU). Given these values, the experimentally determined PRU/spore for Bacillus anthracis was approximately 2×10⁷ and thus about 2-fold compared to a monolayer coverage.

Accordingly, the spores take up about two times more polymer than required for “monolayer coverage”. The excess could be due to spore penetration by the polymer. In a parallel experiment, spores incubated with a solution of polymer 1 were collected by centrifugation, re-suspended in aqueous medium and exposed to white light for various time periods. It was found that the level of bacterial survival (as measured by spore growth in sheep blood agar growth medium) was reduced to <5% of control, indicating a near total kill of the polymer-coated spores by very short exposure to light absorbed by the polymer. Further, the level of bacterial survival was more-or-less independent of exposure time.

A similar low level of bacterial survival (i.e., 98.9% spores killed) was found when spores were suspended in aqueous solutions of polymer where the initial concentration of polymer was sufficient only to give ˜2 times monolayer coverage (i.e., 2×10⁻⁷ M for 1×10⁶ spores). Suspension of the same number of spores with concentrations 10-fold and 100-fold lower resulted in 26.3% and 7.5% inhibition of bacterial survival, respectively. Prolonged irradiation of aqueous suspensions of B. anthracis and polymer 1 or aqueous polymer 1 (without spores) showed that in each case there was very little (i.e., less than 3 to 5%) photobleaching of the polymer for periods up to 19 hr at 25° C.

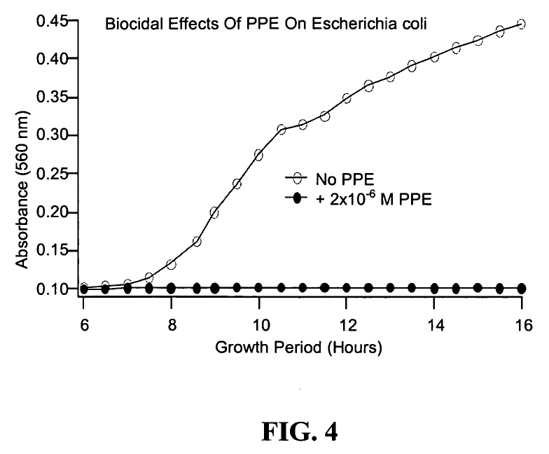

Similar biocidal behavior was observed for E. coli treated with solutions of polymer 1. Incubation with polymer concentrations sufficient to provide several fold the estimated monolayer coverage concentration and exposure to white light for short periods resulted in total inhibition of E. coli growth as measured by changes in optical density at 560 nm (light scattering) (See FIG. 4). The estimated monolayer coverage concentration was 5×10⁻⁷ M of polymer 1. Bacteria treated similarly without polymer or polymer-incubated bacteria not exposed to white light showed no growth inhibition. As the amount of polymer in the solution was reduced to sub-monolayer (i.e., 2×10⁻⁷ M), there was progressively less inhibition of the onset of bacterial growth.

FIG. 4 shows the biocidal activity of polymer 1 toward Escherichia coli. Escherichia coli (8×10⁵ cells) were grown in Luria-Bertani broth (LB) containing ampicillin (LB+amp) at 37° C. in the presence (closed circles) or absence (open circles) of 2×10⁻⁶ M of polymer 1. Growth was monitored by measuring the absorbance at 560 m over 16 hours at half-hour intervals. The absorbance was corrected by incorporating various controls including the absorbance from E. coli growth media alone. The absorbance of E. coli grown in presence of 2×10⁻⁶ M polymer 1 was indistinguishable from the absorbance of the media alone over the entire growth kinetics.

From the experiments described above, it is concluded that polymer 1 exhibits biocidal effects when: (a) it associates with the cell surface of either B. anthracis spores or E. coli; and (b) the cell surface coated polymer is activated by absorbing visible light.

While not wishing to be bound by theory, the participation of cell-penetrated polymer 1 in biocidal activity toward these organisms cannot be excluded based upon currently available data. The effect of the cell surface coating on biocidal activity can also be demonstrated with two cationic surfactants. As mentioned above, coating of the non-light absorbing quaternary ammonium surfactant DTAB on B. anthracis spores resulted in an approximately 40% reduction of bacterial survival at concentrations of 8×10⁻⁶ M or higher which is well below the critical micellar concentration (cmc) of DTAB. This cationic surfactant should associate with the spore coat and would perhaps be more likely to penetrate into the cell than polymer 1.

Another cationic surfactant that would be expected to be more toxic to cells due to its redox activity, cetyl pyridinium chloride, was also found to be an effective dark biocidal reagent toward both B. anthracis and E. coli. For this cationic surfactant, almost total inhibition of E. coli growth was observed at concentrations of 2×10⁻⁵ M or above.

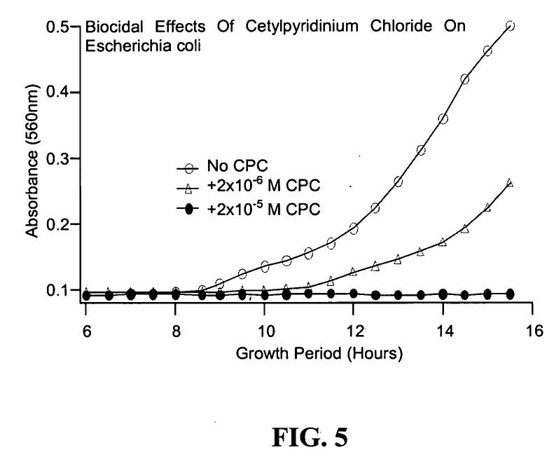

FIG. 5 shows the biocidal activity of cetylpyridinium chloride (CPC) toward Escherichia coli. Escherichia coli (1.6×10⁶ cells) were grown in Luria-Bertani broth containing ampicillin (LB+amp) at 25° C. in the presence of 2×10⁻⁶ M (open triangles) or 2×10⁻⁵ M (closed circles) cetylpyridinium chloride as well as in the absence (open circles) of cetylpyridinium chloride. Growth was monitored by measuring the absorbance at 560 nm over 16 hours at half-hour intervals. The absorbance was corrected by incorporating various controls including the absorbance from E. coli growth media alone. The absorbance of E. coli grown in presence of 2×10⁻⁵ M cetylpyridinium chloride was indistinguishable from the absorbance of the media alone over the entire growth kinetics.

A similar effect was observed for B. anthracis with cetyl pyridinium chloride (data not shown). In particular, there was a near complete (i.e., 98.6% kill) inhibition of spore growth at concentrations greater than 2×10⁻⁶ M. Since these “simple” surfactants do not absorb visible light, no effect of room light was anticipated or observed.

The biocidal effect of even weak irradiation on the activity of polymer 1 is understandable given the excellent light harvesting properties of conjugated polyelectrolytes such as polymer 1 which has an extinction coefficient of 42,000 M⁻¹ cm⁻¹ per PRU. Several mechanisms for the photoactivated biocidal effect might be advanced. However it is known that singlet oxygen can kill cells [35-37] and there are reports of biocidal activity for singlet oxygen sensitizers [38-40]. The lifetime of singlet oxygen in water is ˜13 microseconds [41]. Given the low “concentrations” of bacteria present in these investigations, it is clear that intervention of singlet oxygen produced by intermolecular photosensitization should be negligible. However interfacial generation of singlet oxygen at the cell surface may be anticipated to be effective in promoting cell damage.

To test whether singlet oxygen generation following photoexcitation of bacterial surface associated polymer 1 may be a possible mechanism we examined the biocidal effect of two dyes that efficiently sensitize singlet oxygen: methylene blue (MB) a cationic dye and Rose Bengal lactone (RBL) (neutral in deionized water) [37]. In initial experiments with each dye at a concentration of 2×10⁻⁶ M, it was found that irradiation of RBL with yellow or white light (both are absorbed by RBL and MB) for two hours resulted in an approximately 40% reduction in survival for B. anthracis. In contrast, irradiation of suspensions of MB and B. anthracis resulted in a 75% reduction in bacterial survival. Studies of the concentration effect of MB on bacterial activity over the concentration range of 2×10⁻⁸ M to 2×10⁻⁴ M showed that reduction of bacterial survival is negligible at lowest concentrations and is highest at approximately 10⁻⁵ M (See Table 3 below).

TABLE 3
Biocidal activity of Methylene Blue Toward Bacillus anthracis Spore
Growth

| Concentrations of MB | spore colonies | % killing |
|---|---|---|
| 0 (control) | 13 | 0 |
| 2 × 10⁻⁸ M | 12 | 8 |
| 2 × 10⁻⁷ M | 10 | 23 |
| 2 × 10⁻⁶ M | 3 | 77 |
| 10⁻⁵ M | 3 | 77 |
| 5 × 10⁻⁵ M | 1 | 92 |
| 2 × 10⁻⁴ M | 13 | 0 |

The inhibition then decreases until no inhibition was seen at concentrations of 2×10⁻⁴ M or higher. These results are consistent with the behavior observed for polymer 1 with both E. coli and B. anthracis. Thus it appears that MB is likely coating the bacterial cell surface (MB has been shown to stain bacterial cells [29, 30, 42]) and then generating singlet oxygen by photoexcitation. The decrease in biocidal activity when the concentration of MB is greater than 10⁻⁴ M is attributable to the same inner filter effect observed for polymer 1. While these results do not establish singlet oxygen generation as the mechanism for the light-induced biocidal activity of polymer 1, they indicate that it may be a possible explanation for the effects.

The biocidal polymers described herein can be used in various applications including military applications. Various applications for the biocidal polymers are set forth below.

Clothing/Uniform Protection and/or Decontamination

Microorganisms which inhabit soil, water or air can proliferate on textiles. Such proliferation can take place on textiles made out of plant or animal fibers and synthetic materials. Although several synthetic materials (such as acrylic, nylon, polyester, polyethylene and polypropylene fibers) are quite resistant to microbial growth, a soldier's environment may cause spills on clothing such as lubricants or oils or even water that could provide a surface for growth of microorganisms. Coating of protective gear with biocidal agents as set forth herein can be used to provide an effective defense against such microbial contamination. Supplemental military applications include reducing odor, prolonging garment life, and reducing or eliminating infections among soldiers who operate in close or confined environment.

Field Equipment Protection and/or Decontamination

Biocides as described herein may also be applied to textiles that are likely to be exposed to soil or severe weathering conditions. These types of materials include cotton and flax canvases, awnings, tarpaulins, cordage, ropes, sacks, tents, shower curtains, mattresses, sleeping bags, and military equipment. Coating of field equipment with biocidal agents as set forth herein can be used to provide an effective defense against microbial contamination and/or to decontaminate contaminated articles.

Hygienic Finishes

Biocides may be used in health-care products. Examples include, but are not limited to, biocidal coatings to resist napkin rash or finishes applied to socks or footwear lining to protect against athlete's foot.

Decontamination Foam

A blend of biocides could be used as a portable decontamination foam concentrate to clean up suspected or actual areas of microbial attack. The biocide is non-corrosive, non-hazardous and potentially compatible with state and local government HAZMAT units.

Fuel Additive

Biocide additives as set forth herein can be used to fight microbial growth in jet fuel. Such biocides will be compatible with fuels, fuel system components, be capable of partitioning between fuel and water and remain with fuel to provide downstream protection.

Aseptic Units

Emergency and field hospitals could benefit from the use of biocides to provide an aseptic environment for treating soldiers exposed to biological attack as well as to minimize or eliminate microbial contamination within such units. Biocidal agents as described herein can be used to provide an aseptic environment.

Antifouling

Antifouling paints comprising biocides mixed with paint have been used on navy and commercial vessels to combat microbial contamination and the formation of biofilms. Efficacy of the biocide toward marine organisms is the key factor in developing antifouling paints. The use of copper as antifouling biocide is getting increasingly restricted due to copper toxicity. Hence alternate biocides are attractive in the development of antifouling paints. Surface-active biocides are very desirable since they minimize leaching and eliminate bioaccumulation and persistence. Sea-bound vessels could include container/cargo ships, bulk carriers, tankers, frigates, cruisers, passenger ferries, research vessels/boats, patrol boats, and fishing vessels. Similar antifouling/biocidal paints could also be used inside military facilities on surfaces such as conference tables, chairs, doors, and any other facility commonly used in military installations. Accordingly, biocidal agents as described herein can be used as an anti-fouling agent or additive.

Disinfectant

In military environment where soldiers live, eat and work together in close proximity, prevention of infectious diseases is a challenge. The use of broad-spectrum, clinically-relevant biocidal disinfectants is a primary defense in preventing, containing or eliminating infectious diseases. A non-toxic biocidal disinfectant that does not require special handling or transport will be highly desirable and effective. Accordingly, biocidal agents as described herein can be used as a disinfectant.

Foul Release & Quorum Sensing

Quorum sensing is a process by which bacteria “know” when they are alone and when they are in a community using chemical communications for interspecies and intra-species recognition. Disrupting quorum sensing is a mechanism for inducing biocidal activity and promoting foul-release. Accordingly, biocidal agents as described herein can be used to induce biocidal activity and promote foul-release.

While the foregoing specification teaches the principles of the present invention, with examples provided for the purpose of illustration, it will be appreciated by one skilled in the art from reading this disclosure that various changes in form and detail can be made without departing from the true scope of the invention.

### REFERENCES

[1] Collins, T. J.; Banerjee, D.; Khetan, S. K.; Yano, T. Abstracts 226th ACS National Meeting, New York, 2003, IEC-158.
[2] Ignatova, M.; Labaye, D.; Lenoir, S.; Strivay, D.; Jerome, R.; Jerome, C. Lanigmuir 2003, 19, 8971-8979.
[3] Goebbert, C.; Schichtel, M.; Nonninger, R. Farbe+Lack 2002, 108, 20-25.
[4] Stoimenov, P. K.; Klinger, R. L.; Marchin, G. L.; Klabunde, K. J. Langmuir 2002, 18, 6679-6686.
[5] Brunt, K. D.; Thompson, S. M. Advances in Coating Technology 1998, 35/1-35/18.
[6] Koper, O. B.; Klabunde, J. S.; Marchin, G. L.; Klabunde, K. J.; Stoimenov, P.; Bohra, L. Curr. Microbiol. 2002, 44, 49-55.
[7] Brunt, K. D.; Wood, P. N. Surface Coatings International 1997, 80, 473-475.
[8] Worley, S. D.; Eknoian, M.; Bickert, J.; Williams, J. F. Abstracts 216th ACS National Meeting, Boston, POLY-410 1998.
[9] Hazziza-Laskar, J.; Helary, G.; Sauvet, G. J. Appl. Polym. Sci. 1995, 58, 77-84.
[10] Hamouda, T.; J. R. Baker, J. Journal of Applied Microbiology 2000, 89, 397-403.
[11] Henning, J.; Muller, F.; Peggau, J. SOFW Journal 2001, 127, 30-35.
[12] Maillard, J.-Y. Society for Applied Microbiology Symposium Series 2002, 31, 16S-21S.
[13] Cen, L.; Neoh, K. G.; Kang, E. T. Langmuir 2003, 19, in press.
[14] Mandeville, R.; Kournikakis, B.; Brousseau, P.; Richard, L. PCT Int. Appl. 2003, WO 2003037331.
[15] Werle, P.; Trageser, M.; Stober, R. 1991, DE 904002404.
[16] Sauvet, G.; Fortuniak, W.; Kazmierski, K.; Chojnowski, J. J. Polym. Sci., Part A: Polym. Chem. 2003, 41, 2939-2948.
[17] Chen, C. Z.; Beck-Tan, N. C.; Dhurjati, P.; Dyk, T. K. V.; LaRossa, R. A.; Cooper, S. L. Biomacromolecules 2000, 1, 473-480.
[18] Shirai, A.; Maeda, T.; Masayo, K.; Kawano, G.; Kourai, H. Biocontrol Science 2000, 5, 97-102.
[19] Wang, H.-H.; Lin, M. S. Journal of Polymer Research 1998, 5, 177-186.
[20] Chen, L.; McBranch, D. W.; Wang, H. L.; Helgeson, R.; Wudl, F.; Whitten, D. G. Proc. Natl. Acad. Sci. U.S.A. 1999, 96, 12287-12292.
[21] Jones, R. M.; Bergstedt, T. S.; McBranch, D.; Whitten, D. J. Am. Chem. Soc. 2001, 123, 6726-6727.
[22] Jones, R. M.; Lu, L.; Helgeson, R.; Bergstedt, T. S.; McBranch, D. W.; Whitten, D. Proc. Natl. Acad. Sci. U.S.A. 2001, 98, 14769-14772.
[23] Lu, L.; Jones, R. M.; McBranch, D.; Whitten, D. Langmuir 2002, 18, 7706-7713.
[24] Jones, R. M.; Bergstedt, T. S.; Buscher, T. C.; McBranch, D.; Whitten, D. Langmuir 2001, 17, 2568-2571.
[25] Kushon, S. A.; Ley, K.; Bradford, K.; Jones, R. M.; McBranch, D.; Whitten, D. Langmuir 2002, 18, 7245-7249.
[26] Kushon, S. A.; Jordan, J. P.; Seifert, J. L.; Nielsen, H.; Nielsen, P. E.; Armitage, B. A. J. Am. Chem. Soc. 2001, 123, 10805-10813.
[27] Hartley, H. A.; Baeumner, A. J. Analytical and Bioanalytical Chemistry 2003, 376, 319-327.
[28] Dang, J. L.; Heroux, K.; Kearney, J.; Arasteh, A.; Gostomski, M.; Emanuel, P. Appl. Environ. Microbiol. 2001, 67, 3665-3670.
[29] Venkateswaran, K.; Murakoshi, A.; Satake, M. Appl. Environ. Microbiol. 1996, 62, 2236-2243.
[30] Brauwer, E. D.; Jacobs, J.; Nieman, F.; Bruggeman, C.; Drent, M. J. Clin. Microbiol. 1999, 37, 427-429.
[31] Weis, C. P.; Intrepido, A. J.; Miller, A. K.; Cowin, P. G.; Durno, M. A.; Gebhardt, J. S.; Bull, R. Journal of the American Medical Association 2002, 288, 2853-2858.
[32] Dull, P. M.; Wilson, K. E.; Kournikakis, B.; Whitney, E. A. S.; Boulet, C. A.; Ho, J. Y. W.; Ogston, J.; Spence, M. R.; Mckenzie, M. M.; Phelan, M. A.; Popovic, A.; Ashford, D. Emerging Infectious Diseases 2002, 8, 1044-1047.
[33] Miao, J.; Hodgson, K. O.; Ishikawa, T.; Larabell, C. A.; LeGros, M. A.; Nishino, Y. Proc. Natl. Acad. Sci. U.S.A. 2003, 100, 110-112.
[34] Maki, N.; Gestwicki, J. E.; Lake, E. M.; Kiessling, L. L.; Adler, J. J. Bacteriol. 2000, 182, 4337-4342.
[35] Pooler, J. P.; Valenzeno, D. P. Medicinal Physics 1981, 8, 614.
[36] Valenzeno, D. P.; Pooler, J. P. Photochem. Photobiol. 1982, 35, 343.
[37] Lamberts, J. J. M.; Schumacher, D. R.; Neckers, D. C. J. Am. Chem. Soc. 1984, 106, 5879-5883.
[38] Danz, R.; Elling, B.; Buechtemann, A. German Patent Application 2001, DE 19935179.
[39] Tzeng, D. D.; Lee, M. H.; Chung, K. R.; DeVay, J. E. Can. J. Microbiol. 1990, 36, 500-506.
[40] Hei, R. D. P.; Hubig, S. M.; Finley, M. J. US Patent Application 2003, WO 2003078557.
[41] Kajiwara, T.; Kearns, D. R. J. Am. Chem. Soc. 1973, 95, 5886-5890.
[42] Bizzozero, E. Archivio per le Scienze Mediche 1923, 45, 241-251.

1. A method of inhibiting the growth of a bacterium comprising:
associating a composition comprising a polymer with the surface of the bacterium; and
subsequently exposing the bacterium to light;
wherein the polymer is selected from the group consisting of a conjugated cationic polyelectrolyte, a neutral conjugated polymer, a dye pendant polymer and copolymers thereof.

2. The method of claim 1, wherein the bacterium is a Escherichia coli or Bacillus anthracis bacterium.

3. The method of claim 1, wherein the polymer is a conjugated cationic polyelectrolyte.

4. The method of claim 1, wherein the polymer comprises a poly(phenylene ethynylene) backbone.

5. The method of claim 1, wherein the polymer comprises a repeating unit having a structure represented by the following formula: 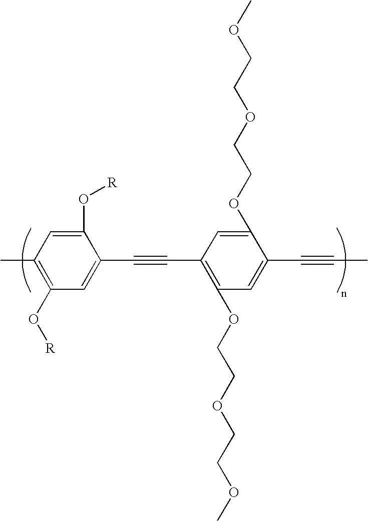
wherein each R independently represents an alkyl quaternary ammonium group or an alkyl pyridinium group.

6. The method of claim 1, wherein the polymer comprises a repeating unit having a structure represented by the following formula:

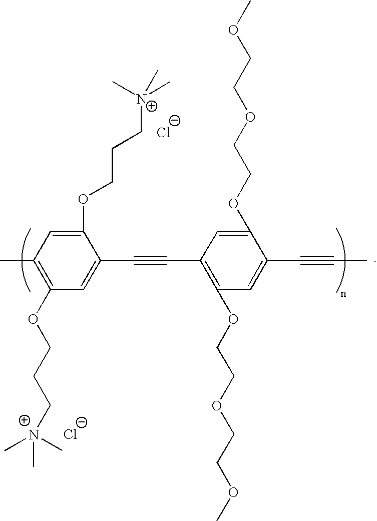

7. The method of claim 1, wherein exposing comprises exposing the bacterium to fluorescent light.

8. The method of claim 1, wherein the composition comprises the polymer at a concentration of 1×10⁻⁴ M to 1×10⁻⁵ M.

9. An article of manufacture comprising:
a textile; and
a polymer associated with the textile;
wherein the polymer is selected from the group consisting of a conjugated cationic polyelectrolyte, a neutral conjugated polymer, a dye pendant polymer and copolymers thereof.

10. The article of manufacture of claim 9, wherein the article is a jacket.

11. The article of manufacture of claim 9, wherein the article is a sock.

12. The article of manufacture of claim 9, wherein the textile comprises cotton fibers.

13. The article of manufacture of claim 9, wherein the textile comprises flax fibers.

14. The article of manufacture of claim 9, wherein the textile is a rope or a cord.

15. A foam composition comprising a polymer selected from the group consisting of a conjugated cationic polyelectrolyte, a neutral conjugated polymer, a dye pendant polymer and copolymers thereof.

16. The foam composition of claim 15, wherein the polymer is a conjugated cationic polyelectrolyte.

17. The foam composition of claim 15, wherein the polymer comprises a poly(phenylene ethynylene) backbone.

18. A fuel composition comprising a polymer selected from the group consisting of a conjugated cationic polyelectrolyte, a neutral conjugated polymer, a dye pendant polymer and copolymers thereof.

19. The fuel composition of claim 18, wherein the polymer is a conjugated cationic polyelectrolyte.

20. The fuel composition of claim 19, wherein the polymer comprises a poly(phenylene ethynylene) backbone.

21. The fuel composition of claim 18, wherein the fuel composition is a jet fuel.

22. A paint composition comprising a polymer selected from the group consisting of a conjugated cationic polyelectrolyte, a neutral conjugated polymer, a dye pendant polymer and copolymers thereof.

23. The paint composition of claim 22, wherein the polymer is a conjugated cationic polyelectrolyte.

24. The paint composition of claim 22, wherein the polymer comprises a poly(phenylene ethynylene) backbone.

25. A method of disinfecting a surface comprising:
contacting the surface with a composition comprising a polymer selected from the group consisting of a conjugated cationic polyelectrolyte, a neutral conjugated polymer, a dye pendant polymer and copolymers thereof; and
subsequently exposing the surface to light.

26. The method of claim 25, wherein the polymer is a conjugated cationic polyelectrolyte.

27. The method of claim 25, wherein the polymer comprises a poly(phenylene ethynylene) backbone.

28. The method of claim 25, wherein the polymer comprises a repeating unit having a structure represented by the following formula: 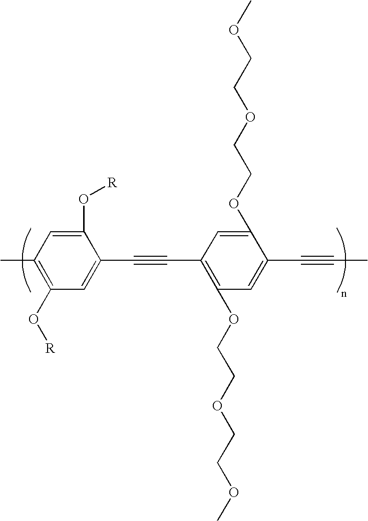
wherein each R independently represents an alkyl quaternary ammonium group or an alkyl pyridinium group.

29. The method of claim 25, wherein the polymer comprises a repeating unit having a structure represented by the following formula:

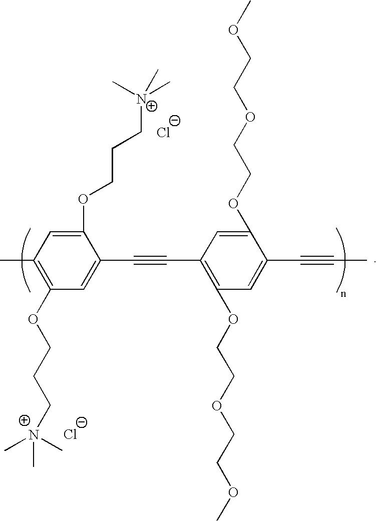

30. The method of claim 25, wherein exposing comprises exposing the bacterium to fluorescent light.

31. The method of claim 25, wherein the composition comprises the polymer at a concentration of 1×10⁻⁴ M to 1×10⁻⁵ M.

32. A method of providing an article with a passive biocidal surface comprising:
coating a surface of the article with a composition comprising a polymer selected from the group consisting of a conjugated cationic polyelectrolyte, a neutral conjugated polymer, a dye pendant polymer and copolymers thereof;
wherein the coating forms a passive biocidal surface on the article.

33. The method of claim 32, wherein coating comprises painting the composition on the surface.

34. The method of claim 32, wherein coating comprises spraying the composition on the surface.

35. The method of claim 32, wherein coating comprises dipping the surface in the composition.
